(19) United States
(12) Patent Application Publication
(10) Pub. No.: US 2010/0055641 A1
(43) Pub. Date: Mar. 4, 2010

(54) DENTAL INSTRUMENT FOR ELIMINATING BROKEN PIECES USING FLEXIBLE GUIDE PLATE

(76) Inventor: Yoshitsugu Terauchi, Kanagawa (JP)

Correspondence Address: BARNES & THORNBURG LLP, 11 SOUTH MERIDIAN, INDIANAPOLIS, IN, 46204, US

(21) Appl. No.: 12/281,861

(22) PCT Filed: Mar. 7, 2007
(86) PCT No.: PCT/JP2007/054416

§ 371 Date: Apr. 28, 2009

(30) Foreign Application Priority Data
Mar. 8, 2006 (JP) 2006-063126

(51) Int. Cl. A61C 3/00

(52) U.S. Cl. 433/75

(57) ABSTRACT

The present invention provides a broken piece-removing device (300) for removing a broken piece of a treatment instrument left in the root canal of a tooth. Specifically, a device for removing a broken piece (300) according to the present invention includes a handle to be held (312), a tensile guide plate (314) protruding at the distal end of the handle (312), and a wire (316) for fastening the broken piece at the distal end of the guide plate (314), the wire (316) having its proximal end located inside the handle (312) and extending to the distal end of the guide plate (314) along the guide plate (314) and forming a loop at the distal end of the guide plate (314), the handle (312) having a controlling portion for constricting a loop (318) formed at the distal end of the guide plate (314) through the wire (316).

### CROSS REFERENCE TO THE RELATED APPLICATIONS

This application claims the benefit of priority to Japanese Patent Application No. 2006-63126, filed on Mar. 8, 2006, which is incorporated herein by reference.

### TECHNICAL FIELD

The present invention relates to dental devices for removing a part of a dental treatment instrument such as a reamer or a file when it is left as a broken piece in the root canal of a tooth.

### BACKGROUND ART

It is easily anticipated that instruments for treatment such as files etc., which are used for enlargement of the root canal in root canal therapy, will become dirty with debris, bacteria, etc., in operations of removing dentin, cement, pulp tissue, etc. For this reason, it is ideal to use disposable instruments for every new patient to be treated. In practice, however, the dentist has usually repeated washing and sterilizing instruments every time after use, and kept using until they turnout to no longer endure further use functionally. In the meantime, because of the continued use, the tip of the instrument is often broken off during treatment and the broken piece is left in the root canal.

To date, devices and methods for removing such a broken piece of a root canal treatment instrument have been developed (Japanese Laid-Open Application No. 2001-269356 and Japanese Laid-Open Application No. 2003-93406) in an effort to solve the problem that the broken piece has been left in the root canal.

### DISCLOSURE OF THE INVENTION

### Problems to be Solved by the Invention

The object of the present invention is to provide a novel device for removing a broken piece with which broken pieces left in variously shaped root canals can be removed.

### Means for Solving the Problems

The broken piece-removing device for removing a broken piece of an instrument left in a root canal of a tooth according to the present invention includes a handle to be held; a tensile guide plate protruding at the distal end of the handle; and a wire for fastening the broken piece at a distal end of the guide plate; the wire having its proximal end located inside the handle and extending to the distal end of the guide plate along the guide plate and forming a loop at the distal end of the guide plate, the handle being mounted with a controlling portion for constricting a loop formed at the distal end of the guide plate through the wire.

Further, in the broken piece-removing device according to the present invention, the guide plate may have two throughholes at the distal end and the wire may form a loop at the distal end of the guide plate by passing through the two throughholes.

Alternatively, in the broken piece-removing device according to the present invention, the guide plate may have a throughhole at the distal end and the wire may form a loop at the distal end of the guide tube by passing through the throughhole and is fixed on the distal end of the guide plate.

In the broken piece-removing device according to the present invention, the controlling portion has a trigger button and, by pressing the trigger button inside the handle, the wire extending along the guide plate is pulled toward the proximal end and thereby the loop formed at the distal end of the guide plate is constricted.

In the broken piece-removing device according to the present invention, the controlling portion is a slidable slide trigger and, by moving the slide trigger toward the proximal end of the handle, the wire extending along the guide plate is pulled toward the proximal end and thereby the loop formed at the distal end of the guide plate is constricted.

Furthermore, in the device for removing a broken piece according to the present invention, it is preferred that the guide plate has a width of 1 mm or less and a thickness of 1 mm or less and that the wire has a diameter of 0.3 mm or less.

### BRIEF DESCRIPTION OF THE DRAWINGS

FIG. 1 shows the structure of the device for removing a broken piece in one embodiment according to the present invention.

FIG. 2 shows a magnified view of the guide plate of the device for removing a broken piece in one embodiment according to the present invention.

FIG. 3 shows the structure of the device for removing a broken piece in another embodiment according to the present invention.

FIG. 4 illustrates a broken piece of a root canal treatment instrument which is left within a curved root canal of a tooth.

FIG. 5 illustrates a broken piece of a root canal treatment instrument left within a curved root canal of a tooth, which is fastened with the device for removing a broken piece in one embodiment according to the present invention.

### DESCRIPTION OF REFERENCE NUMERALS

300, 400: Device for removing a broken piece

312, 412: Handle

314, 414: Guide plate

316, 416: Wire

318, 418: Loop

320: Slide trigger

322: Wire-fixing site

### DETAILED DESCRIPTION OF THE INVENTION

The object, characteristics, and advantages of the present invention as well as the idea thereof will be apparent to those skilled in the art from the descriptions given herein. It is to be understood that the embodiments of the invention described herein below are to be taken as preferred embodiments of the present invention. These descriptions are only for illustrative and explanatory purposes and are not intended to limit the invention to these embodiments. It is further apparent to those skilled in the art that various changes and modifications may be made based on the descriptions given herein within the intent and scope of the present invention disclosed herein.

### ==Structure of the Device for Removing a Broken Piece ==

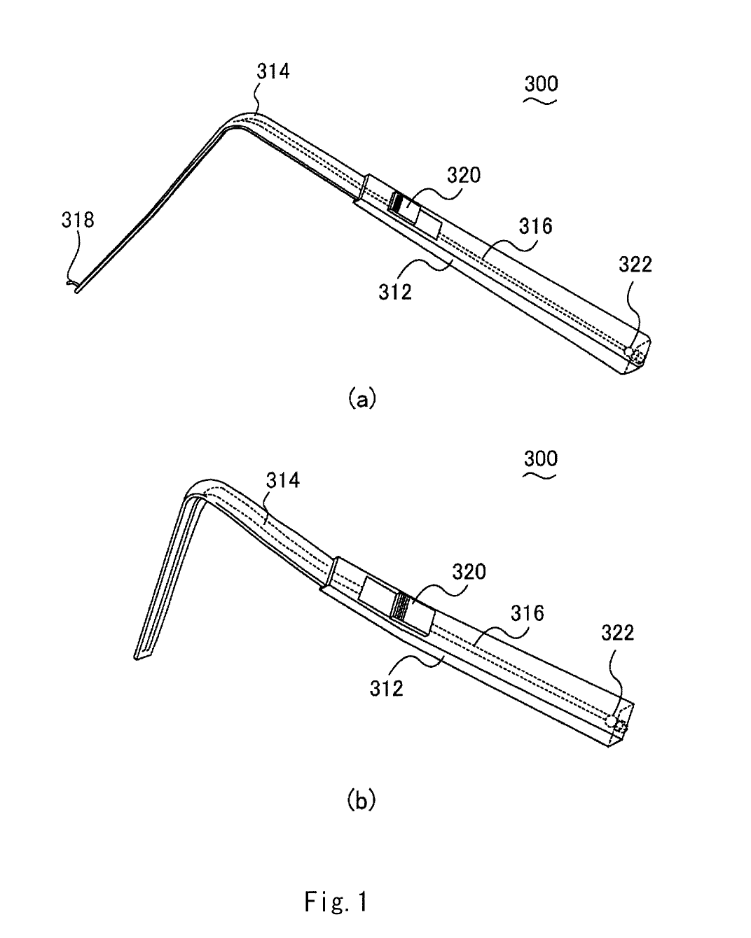

FIG. 1 shows the structure of the device for removing a broken piece in one embodiment according to the present invention. The device for removing a broken piece 300 includes a handle 312 to be held by the operator; a guide plate 314 protruding at the distal end of the handle 312; a wire 316 running through the handle 312, passing inside the guide plate 314, and forming a loop at the distal end of the guide plate; and a controlling portion for constricting the loop on the handle 312. The controlling portion is provided to, by pulling the wire 316 backward toward the proximal end of the guide plate 314, adjust the length and tension of the wire 316 and thereby constrict the loop formed at the distal end of the guide plate 314. It should be noted that, in this embodiment, a slide trigger 320 is provided on the handle 312 as the controlling portion.

As shown in FIG. 1 (a), the handle 12 is hollow and made from a material that ensures a size and shape allowing easy hand gripping and handling as well as good hygiene, as with common dental instruments. A wire-fixing site 322 for fixing the terminal end of the wire 316 is provided inside the proximal end of the handle 312.

As shown in FIG. 4, when a broken piece of a root canal treatment instrument is left in a curved root canal of a tooth, it has been difficult to remove the piece left in the root canal as shown in FIG. 4 with a conventional device for removing a broken piece. Moreover, although it is possible to form a straight pathway to the broken piece by grinding the root canal, this requires grinding of considerably a large part of the root canal. Such operation is a big burden not only on the root canal but also on the whole teeth and is therefore impracticable.

Accordingly, to reach the broken piece left at the tip of the curved root canal, it is required that the portion to be introduced into the root canal of a device for removing a broken piece should fit the shape of the root canal. However, if the portion to be introduced into the root canal of a device for removing a broken piece bends before insertion, the device cannot be introduced along the vertical portion of the root canal as a matter of course. Therefore, it is preferred that the portion to be introduced into the root canal of the device for removing a broken piece bends after it has been introduced along the vertical part of the root canal.

Thus, the guide plate 314 is a sleeve composed of flexible substances such as nickel, titanium, stainless steel, cobalt, chromium, aluminum, alloys thereof (e.g., a nickel titanium alloy, a cobalt chromium alloy), carbon fiber, etc. The thickness of the guide plate 314 is preferably 0.03 mm to 1 mm, and more preferably 0.08 mm to 0.5 mm; and its width is preferably 0.3 mm to 1 mm, and more preferably 0.4 mm to 0.6 mm, so as to be able to move without being obstructed inside the root canal and to have the curved portion return to the starting shape when the portion moves backward the vertical portion of the root canal. As shown in FIG. 1 (a), it is preferred that the guide plate 314 has a uniform thickness from the proximal end to the distal end of the guide plate 314, but it may have a tapered structure such that the vicinity of the proximal end of the guide plate 314 is thicker and the thickness decreases in a direction toward the distal end of the guide plate 314. Also, it is preferred that the guide plate 314 has a uniform width from the proximal end to the distal end of the guide plate 314, but it may have a tapered configuration such that the width at the proximal end of the guide plate 314 decreases in a direction toward the distal end of the guide plate 314, as with the thickness of the guide plate 314.

The guide plate 314 is preferably curved as a whole so as to be easily introduced into the oral cavity over the dental arch, but the shape of the guide plate 314 is not limited to a curve; it may take some other shape, considering easier operation allowing the device to be introduced according to a site to be operated.

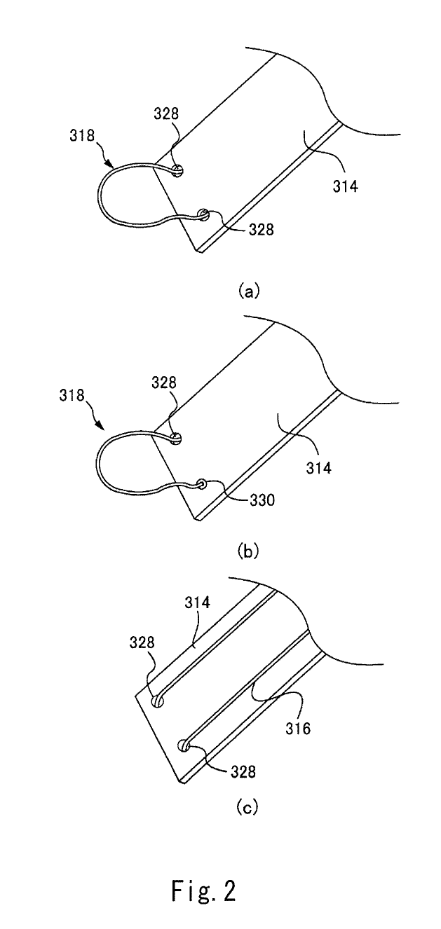

The wire 316 is a nickel-plated high strength single wire made of stainless steel with a diameter of 0.03 to 0.3 mm. Its diameter is preferably about 0.06 to 0.12 mm but its material and diameter are not particularly limited. As shown in FIG. 2 (a), the tip, i.e., the distal end, of the guide plate 314 is provided with a pair of small throughholes 328. The wire 316 forms a loop 318 at the distal end of the guide plate 314 with its both ends passing through the respective small throughholes 328, runs through the backside of the guide plate 314 and the inside of the handle 312, so that both of the terminal ends are connected to the wire fixing site 322. FIG. 2 (c) shows a magnified view of the inside of the distal end of the guide plate 314 in such an example. Alternatively, as shown in a magnified view of FIG. 2(b), the wire 16 running through backside of the guide plate 314 may protrude from a small throughhole 328, form a loop 318, and then be fixed to a fixing site 330 at the tip of the guide plate 314.

In FIG. 1 (a), a slide trigger 320 provided as a controlling portion is closely attached to the wire 316 inside the handle 312. As shown in FIG. 1 (b), by sliding this slide trigger 320 toward the proximal end of the handle 312 from the fixed position shown in FIG. 1 (a), the wire 316 closely attached to the slide trigger 320 is pulled toward the proximal end of the handle 312, thereby the diameter of the loop 318 formed in the distal end of the guide plate 314 is reduced. Thus, the device is structured so that the diameter of the loop 318 is controlled depending on the distance for which the slide trigger 320 is slided toward the proximal end of the handle 312 from the fixed position.

### ==Operation of the Device for Removing a Broken Piece ==

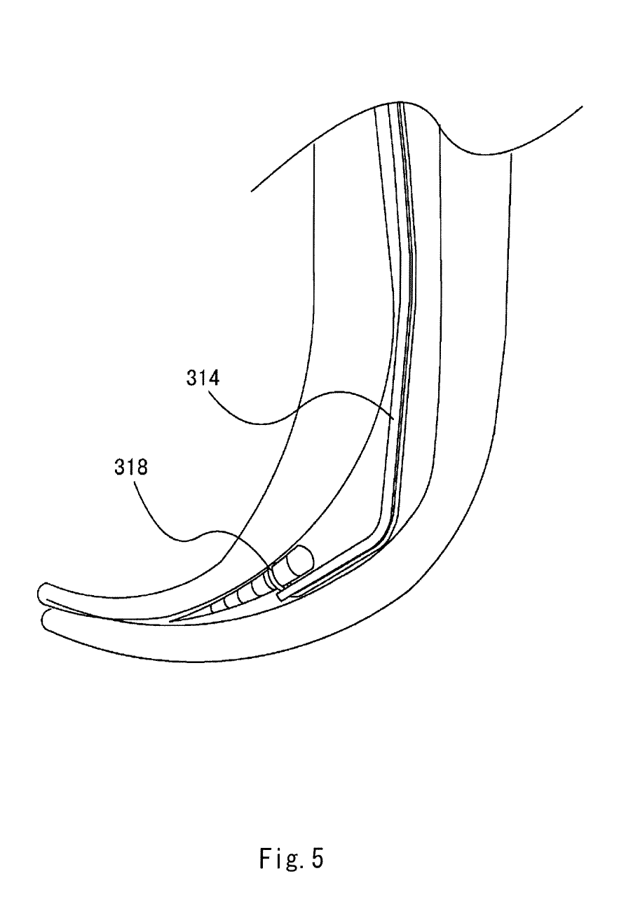

As shown in FIG. 4, to remove a broken piece left in a curved root canal, the guide plate 314, serving as the portion to be introduced into the root canal in the device for removing a broken piece 300 according to the present invention, is introduced into the root canal. Since the entrance portion of the root canal is vertical, the guide plate 314 enters vertically in this vertical portion of the root canal, proceeds while changing its shape into the curved portion following the vertical portion, and reaches the broken piece left at the tip of the root canal (see FIG. 5). When the guide plate 314 has reached the broken piece, it is situated under the broken piece and the broken piece is retained by the loop 318 and is constricted by controlling the slide trigger 320 so that the broken piece is fastened. Thus, the broken piece is securely fixed on the guide plate 314 so that the broken piece is prevented from slipping off the loop 318 when the guide plate 314 is taken out from the inside of the root canal. Then, by drawing the device for removing a broken piece 300 out of the oral cavity with the broken piece fixed on guide plate 314, the broken piece can be successfully removed.

It should be noted that, before introducing the guide plate 314 into the root canal, in order to secure space allowing insertion of the guide plate 314 between the broken piece left in the root canal and the root canal wall, it is desirable to remove dentine surrounding the broken piece with a cutting instrument or the like (for example, refer to Japanese Laid-Open Application No. 2003-93406).

### ==Another Configuration of the Device for Removing a Broken Piece ==

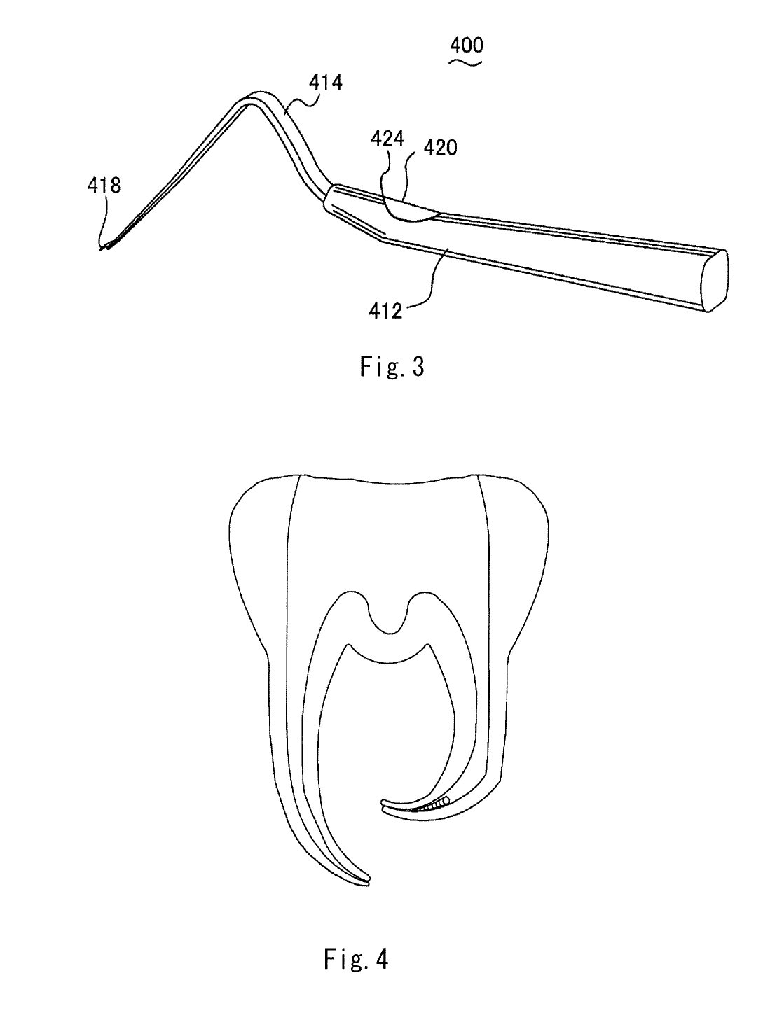

FIG. 3 illustrates another structure of the device for removing a broken piece. In a device for removing a broken piece 400, the basic structure is the same as that of the device for removing a broken piece 300, except that a trigger button 420 replaces the controlling portion of the device for removing a broken piece 300.

The trigger button 420 fits into a slot formed in a handle 412, with its outer surface flush with the handle 412 and inner surface arcuately bulged towards the interior of the handle 412. A trigger holder 424 is hinged to the trigger button 420. Using this trigger holder 424 as a pivot, the trigger button 420 is pressed inside the handle 412. By providing an elastic body (not shown in the drawings)such as a spring in the interior of the handle 412, so that this elastic body is contacted with the arcuately bulged inner surface of the trigger button 420, the external surface of the trigger button 420 may be kept flush with the handle 412. Alternatively, by providing an elastic body onto the trigger holder 424 so that when the trigger button 420 is pushed inside the handle 412 the force is repelled by the elastic body, the external surface of the trigger button 420 can be kept flush with the handle 412. In these conditions where a flush relationship is maintained, the inner surface of the trigger button 420 is in touch with the wire 416 (not shown in the drawings).

When the trigger button 420 is pressed inside the handle 412 so as to adjust the diameter of the loop, a wire 416 bows; accordingly, the wire 416, situated from the contact point of the trigger button 420 and the wire 416 to the distal end of the handle 412, is pulled toward the proximal end of the handle 412. As a result, the diameter of a loop 418 formed in the distal end of the guide plate 414 becomes smaller. In this structure, the magnitude of the diameter of the loop 418 is controlled by the distance for which the trigger button 420 is pushed inside.

### INDUSTRIAL APPLICABILITY

By using the device for removing a broken piece according to the present invention, it becomes possible to remove a broken piece of the root canal treatment instrument which is left in a variously shaped root canal.

1. A broken piece-removing device for removing a broken piece of an instrument left in a root canal of a tooth comprising:
a handle to be held;
a tensile guide plate protruding at the distal end of the handle; and
a wire for fastening the broken piece at the distal end of the guide plate, the wire having its proximal end located inside the handle and extending to the distal end of the guide plate along the guide plate and forming a loop at the distal end of the guide plate, the handle being mounted with a controlling portion for constricting a loop formed at the distal end of the guide plate through the wire.

2. The broken piece-removing device of claim 1,
wherein the guide plate has two throughholes at the distal end, and
the wire forms a loop at the distal end of the guide plate by passing through the two throughholes.

3. The broken piece-removing device of claim 1,
wherein the guide plate has a throughhole at the distal end, and
the wire forms a loop at the distal end of the guide tube by passing through the throughhole and is fixed on the distal end of the guide plate.

4. The broken piece-removing device of claim 1,
wherein the controlling portion has a trigger button and, by pressing the trigger button inside the handle, the wire extending along the guide plate is pulled toward the proximal end and thereby the loop formed at the distal end of the guide plate is constricted.

5. The broken piece-removing device of claim 1, wherein the controlling portion is a slidable slide trigger and, by moving the slide trigger toward the proximal end of the handle, the wire extending along the guide plate is pulled toward the proximal end and thereby the loop formed at the distal end of the guide plate is constricted.

6. The broken piece-removing device of claim 1, wherein the guide plate comprises a width of 1 mm or less and a thickness of 1 mm or less.

7. The broken piece-removing device of claim 1, wherein the wire comprises a diameter of 0.3 mm or less.
